(19) United States
(12) Patent Application Publication
(10) Pub. No.: US 2025/0218261 A1
(43) Pub. Date: Jul. 3, 2025

(54) METHODS AND SYSTEMS FOR DETERMINING AN OBJECT STATE

(71) Applicant: Comcast Cable Communications, LLC, Philadelphia, PA (US)

(72) Inventors: Zhe Wu, Philadelphia, PA (US); Chuanxi Xu, Philadelphia, PA (US); Ehsan Younessian, Philadelphia, PA (US); Luke DeLuccia, Philadelphia, PA (US); Anthony Braskich, Philadelphia, PA (US)

(21) Appl. No.: 18/403,349

(22) Filed: Jan. 3, 2024

(51) Int. Cl. G08B 13/196

(52) U.S. Cl. CPC G08B 13/19606; G08B 13/1961

(57) ABSTRACT

A camera system may automatically identify regions/objects of interest in a field of view of the camera system. Analysis of motion events or other changes associated with the region or object of interest may be performed. Based on the motion events or other changes associated with the region or object of interest, an object state may be determined.

### BACKGROUND

Premises monitoring systems (e.g., security systems and other similar systems) usually include cameras and other specialized sensors to detect when a premises has been comprised (e.g., when an intruder enters the home). For example, a camera or motion sensor may determine the premises has been compromised based on visual data. Meanwhile, specialized sensors like door and window sensors may determine that a door has been forced open or a window broken. These systems, however, require expensive, custom sensors that require expertise to install and operate. Further, most of these systems only detect when an intrusion has occurred, and do not alert homeowners to potential vulnerability before the premises is comprised. In order to determine the vulnerability ahead of time, a user would have to look at a camera's feed and observe, that, for example, a door or window has been left open. These systems cannot properly alert a user to a vulnerability when there is occlusion or obscuring of an object of interest. Thus, improved premises monitoring systems are needed.

### SUMMARY

It is to be understood that both the following general description and the following detailed description are explanatory only and are not restrictive. Methods and systems are described for determining an object state. A camera system (e.g., a smart camera, a camera in communication with a computing device, etc.) may identify/detect objects of interest within a field of view. The system may determine an object of interest based on a frequency of activity/motion associated with the object of interest or the object may be identified and/or designated upon configuration of the system. The camera system may be used for long-term analysis of activity/motion events detected at different regions of a scene within its field of view, such as a user's garage door, window, or other point of entry, and the like, over an extended time period (e.g., hours, days, etc.). The camera system may determine a region of interest associated with an object of interest. The camera system may determine one or more weighted sections of the region of interest associated with the object of interest. The camera system may capture/detect similar activity/motion events frequently occurring within a certain region and record (e.g., store, accumulate, etc.) statistics associated with each activity/motion event. The camera system may identify/detect regions within its field of view, objects within the regions, actions/motions associated with the objects, or the like. Regions (images of the regions, etc.) and/or objects within field of view of the camera system may be tagged with labels that identify the regions or objects, such as, “garage” “garage door,” “front door,” “window,” “street,” “sidewalk,” “private walkway,” “private driveway,” “private lawn,” “private porch,” and the like. The camera system may determine the regions and objects within its field of view and the information may be used to train the camera system and/or a neural network associated with the camera system to automatically detect/determine regions within its field of view.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, and together with the description, serve to explain the principles of the methods and systems:

FIG. 1 shows an example system;

FIG. 2 shows an example system;

FIG. 3 shows an example method;

FIG. 4 shows an example method;

FIG. 5 shows an example method;

FIGS. 6A-6B show example interfaces;

FIGS. 7A-7B show example methods;

FIG. 8 show an example method;

FIG. 9 shows an example method;

FIG. 10 shows an example method;

FIG. 11 shows an example method;

FIG. 12 shows an example method; and

FIG. 13 shows an example system.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular features only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another range includes from the one particular value and/or to the other particular value. Similarly, when values are expressed as approximations, by use of the antecedent “about,” it will be understood that the particular value forms another value. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Such as” is not used in a restrictive sense, but for explanatory purposes.

Components that may be used to perform the present methods and systems are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all sections of this application including, but not limited to, steps in described methods. Thus, if there are a variety of additional steps that may be performed it is understood that each of these additional steps may be performed with any specific step or combination of steps of the described methods.

As will be appreciated by one skilled in the art, the methods and systems may be implemented using entirely hardware, entirely software, or a combination of software and hardware. Furthermore, the methods and systems may take the form of a computer program product on a computer-readable storage medium having computer-readable program instructions (e.g., computer software) encoded on the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described below with reference to block diagrams and flowchart illustrations of methods, systems, apparatuses and computer program products. It will be understood that each block of the block diagrams and flowcharts, and combinations of blocks in the block diagrams and flowcharts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

Note that in various cases described herein reference may be made to a given entity performing some action. It should be understood that this language may in some cases mean that a system (e.g., a computer) owned and/or controlled by the given entity is actually performing the action.

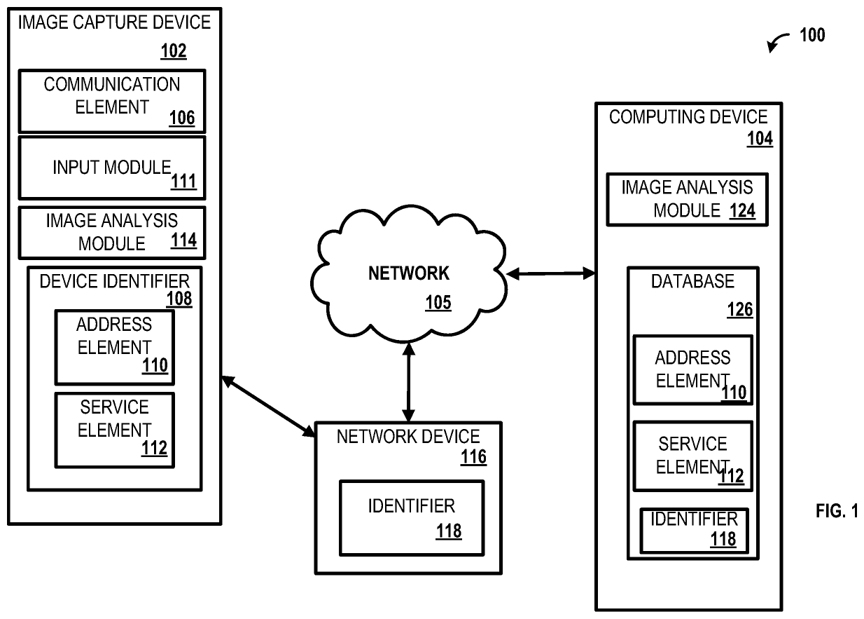

The present disclosure is relevant to systems and methods for determining object state and/or object activity within a region of interest. FIG. 1 shows an example camera system 100 configured to facilitate the methods described herein. The system 100 may comprise an image capture device 102 in communication with a computing device 104 such as a server. The computing device 104 may be disposed locally or remotely relative to the image capture device 102. The image capture device 102 and the computing device 104 may be in communication via a private and/or public network 105 such as the Internet or a local area network. Other forms of communications may be used such as wired and wireless telecommunication channels.

The image capture device 102 may comprise an electronic device such as a smart camera, a video recording and analysis device, a communications terminal, a computer, a display device, or other device capable of capturing images, video, and/or audio and communicating with the computing device 104. The image capture device 104 may comprise one or more photosensors/photodectors. For example, the image capture device may comprise one or more photodiodes, one or more charge-coupled devices (CCDS), combinations thereof, and the like. A photodiode is a semiconductor device that generates a current or voltage in response to the amount of light falling on it. When exposed to light, the photodiode generates an electrical current or voltage, which can be digitized using analog-to-digital converters (ADCs) to produce digital data. CCDS are composed of an array of photosensitive elements that accumulate and store electrical charge when exposed to light. The accumulated charge may then be read out (e.g., one row at a time), and converted into digital data through one or more analog-to-digital converters.

The system 100 may be configured to determine one or more states of one or more objects of interest. The one or more objects of interest may be associated with one or more regions of interest in a field of view of the image capture device 102. The system 100 may be configured to automatically determine the one or more regions of interest based on the occurrence of motion within one or more regions of the field of view. The system may be configured to determine one or more regions of interest and/or one or more objects of interest. For example, the system may be configured to determine the one or more regions of interest and/or the one or more objects of interest based on one or more motion indications. The one or more motion indications may be determined based on detecting one or more motion events (e.g., real world events). The one or more motion indications may be configured to indicate that motion has occurred in the field of view (e.g., a door opening or closing).

For each frame of the video, a change in pixels from a previous frame may be determined. If a change in a pixel (e.g., one or more pixels, etc.) is determined, the frame may be tagged with a motion indication. The motion indication may comprise a predefined value (e.g., 1) at a location in the frame (e.g., in the scene, in the field of view) where the change of pixel occurred. If it is determined that no pixels changed (e.g., one or more pixels, etc.), the frame may be not be tagged or may be tagged with a motion indication with a different predefined value (e.g., 0). A plurality of frames associated with the video may be determined and a plurality of motion indications may be determined and/or stored. A plurality of frames associated with the video may be determined and a plurality of motion indication may be determined and/or stored over a time period (e.g., a day(s), a week(s), etc.). The plurality of motion indications may be compared to a threshold. An amount of motion indications with a value of 1 may satisfy or exceed a threshold value, such as 99 motion indications with a value of 1 may exceed a threshold value set for 55 motion indications with a value of 1. A threshold value may be based on any amount or value of motion indications. A region of interest (ROI) within the field of view of the camera may be determined based on the plurality of motion indications compared to a threshold.

The system 100 may be used for long-term analysis of activity/motion events detected at different regions of a scene within its field of view and/or associated with one or more objects in the field of view, such as a user's garage door, front door, one or more windows, one or more appliance doors, one or more baby gates, or any other openable or movable structure, over an extended time period (e.g., hours, days, etc.). The system 100 may capture/detect similar activity/motion events frequently occurring within a certain region and record (e.g., store, accumulate, etc.) statistics associated with each activity/motion event. Regions within the field of view of the system 100 with high frequency activity/motion may be identified/determined as regions of interest and or objects of interest. A notification may be sent to the user that requests the user confirm whether the user desires continued notification of a particular region and/or frequently occurring activity/motion event. A user may be notified that a region within the field of view of the camera is associated with a plurality of motion indications that satisfy, do not satisfy, or exceed a threshold value.

The state change may or may not comprise motion. For example, in the case of an appliance heating up, the state change may be determined based on a color change or some other visual change. For example, when a stope top is cool, it may be black, but as the stop top heats up, the color changes from black to red. Thus, objects or interest and/or regions of interest may be determined based on any visual changes, not just motion indications.

The system 100 may notify the user (e.g., a user device, etc.) via a short range communication technique (e.g., BLUETOOTH®, near-field communication, infrared, etc.) or a long range communication technique (e.g., WIFI, cellular, satellite, Internet, etc.). The notification may be a text message, a notification/indication via an application, an email, a call, or any type of notification. The user may receive a message via a user device such as “do you want to be notified when the door is open?” “do you want to ignore the event and/or events in this region?” “do you want to be notified when this object moves?” “do you want to be notified when the object state changes?” or any other type of message. If the user does not desire continued notification of the particular region and/or the frequently occurring activity/motion event, the camera may cease such notifications and/or filter/cease detection of the particular region and/or the frequently occurring activity/motion event.

The system 100 may identify/detect regions within its field of view, objects within the regions, actions/motions associated with the objects, or the like. The system 100 may determine regions within its field of view and images of the regions may be tagged with region-labels that identify the regions. Images of the regions may be tagged with labels such as, “garage door,” “front door,” “baby gate,” “refrigerator door,” and the like. The system 100 may determine the regions within its field of view based on user provided information. The user may use an interface in communication with and/or associated with the system 100 that displays the camera system's field of view to identify (e.g., draw, click, circle, etc.) the regions.

The system 100 may be configured to determine the regions within its field of view by automatically identifying/detecting the regions and sending notifications to the user when a motion event is detected in an automatically identified/detected region or regions. The user may use the interface in communication with and/or associated with the camera system to view the notifications and to provide feedback indications (e.g., a “Thumbs Up” button indicative of a notification being helpful; a “Thumbs Down” button indicative of a notification being unhelpful, and the like). The feedback indications may be sent through the interface to the camera system. Based on the feedback indications provided from the user after viewing a notification(s), the camera system may continue or may cease providing notifications for the region or regions associated with the notification(s). The camera system may continue providing notifications for the region or regions associated with the notification(s) when the feedback indicates the notification(s) are helpful or desirable (e.g., an indication of a “Thumbs Up” in response to viewing the notification(s); an indication that the notification(s) was viewed at least once; and the like). The camera system may cease providing notifications for the region or regions associated with the notification(s) when the feedback indicates the notification(s) are not helpful or not desirable (e.g., an indication of a “Thumbs Down” in response to viewing the notification(s); an indication that the notification(s) was not viewed; and the like).

A region segmentation map may be generated, based on the identified/detected regions. One or more region segmentation maps and associated information may be used to train the camera system and/or any other camera system (e.g., a camera-based neural network, etc.) to automatically identify/detect regions of interest (ROIs) and/or objects of interest within a field of view. The system 100 may automatically determine that a region within its field of view contains a door or window and whether or not the door or window is open. The system 100 may determine an object state. An object state may be “open,” “closed,” “mostly closed,” “mostly open,” “ajar,” combinations thereof, and the like.

The system 100 may determine one or more sections of the region of interest. The system 100 may determine one or more weights associated with the one or more sections of the region of interest. Thus, one or more weighted sections of the region of interest may be determined. The region of interest may comprise one or more weighted sections. The one or more weighted sections may comprise one or more groupings of pixels that represent the object/region of interest. In some cases, there may be weighting associated with some pixels that are more important (e.g., more reliable) than other pixels. For example, the system may only consider a single weighted section as that weighted section may be 100% indicative of the object state. For example, the system may rely on (e.g., consider) a combination of weighted segments if, for example, no single weighted section is 100% accurate or 100% reliable.

A mask may be generated based on the region of interest. Each of the one or more weighted sections may be associated with a different weight. The one or more weights may indicate how reliably the one or more sections indicate the state of the object. The one or more weights may indicate an association between the one or more values and one or more states of the object (e.g., fully open, partially open, closed). For example, data values (e.g., grayscale data, color data, etc.) may be strongly associated with a state of the object. For example, a first weighted section of the region of interest may always be dark when the door is closed while a second weighted section of the region of interest may always be light when the door is closed. Conversely, the first weighted section may always be light when the door open (even partially open), while the second weighted section may always be light regardless of whether the door is open or closed. Thus, the image data of the first weighted section is strongly associated with the state of the object while the image data of the second weighted section is not strongly associated with the state of the object.

The system 100 may only be concerned (e.g., perform identification/detection, etc.) with region(s) within its field of view determined to be a particular region(s). The system 100 may only be concerned with a region within its field of view determined to be an openable structure. The system 100 may only be concerned (e.g., perform identification/detection, etc.) with a particular region within its field of view to reduce analysis of unnecessary information (e.g., actions, motions, objects, etc.) of other regions within its field of view. The system 100 may be configured to detect a particular object and/or action/motion occurring in the particular region within its field of view, such as a person walking towards the front door of a house. The system 100 may be configured to ignore (e.g., not detect, etc.) a particular object and/or action/motion occurring in the particular region within its field of view, such as a person walking along a sidewalk. The system 100 may use scene recognition to automatically identify regions, objects, and actions/motions occurring in a scene with in its field of view that may be a layout that is new to the system 100 (e.g., the front yard of a location where the camera of the camera system is newly installed, etc.). The system 100 (or any other camera system, etc.) may abstract away appearance variations between scenes within its field of view (e.g., variations in scenes caused by a change in a location of the camera system).

To abstract away appearance variations between scenes within its field of view, the system 100 may use a layout-induced video representation (LIVR) method to encode a scene layout based on a region segmentation map determined from a previous scene in the camera system's field of view.

The image capture device 102 may comprise a communication element 106. The communication element 106 may be configured to provide an interface to a user to interact with the image capture device 102 and/or the computing device 104. The communication element 106 may comprise any interface for presenting and/or receiving information to/from the user, such as a notification, confirmation, or the like associated with a region of interest (ROI), an object, or an action/motion within a field of view of the image capture device 102. An interface may be a communication interface such as a display screen, a touchscreen, an application interface, a web browser (e.g., Internet Explorer®, Mozilla Firefox®, Google Chrome®, Safari®, or the like). Other software, hardware, and/or interfaces may be used to provide communication between the user and one or more of the image capture device 102 and the computing device 104. The communication element 106 may request or query various files from a local source and/or a remote source. The communication element 106 may send data to a local or remote device such as the computing device 104.

The image capture device 102 may comprise a device identifier 108. The device identifier 108 may be any identifier, token, character, string, or the like, for differentiating one image capture device (e.g., image capture device 102) from another image capture device. The device identifier 108 may identify an image capture device as belonging to a particular class of image capture devices. The device identifier 108 may comprise information relating to an image capture device such as a manufacturer, a model or type of device, a service provider associated with the image capture device 102, a state of the image capture device 102, a locator, and/or a label or classifier. Other information may be represented by the device identifier 108.

The device identifier 108 may be an address element 110 and a service element 112. The address element 110 may be or provide an internet protocol address, a network address, a media access control (MAC) address, an Internet address, or the like. The address element 110 may be relied upon to establish a communication session between the image capture device 102 and the computing device 104 or other devices and/or networks. The address element 110 may be used as an identifier or locator of the image capture device 102. The address element 110 may be persistent for a particular network.

The service element 112 may comprise an identification of a service provider associated with the image capture device 102 and/or with the class of image capture device 102. The class of the user device 102 may be related to a type of device, capability of device, type of service being provided, and/or a level of service (e.g., business class, service tier, service package, etc.). The service element 112 may comprise information relating to or provided by a communication service provider (e.g., Internet service provider) that is providing or enabling data flow such as communication services to the image capture device 102. The service element 112 may comprise information relating to a preferred service provider for one or more particular services relating to the image capture device 102. The address element 110 may be used to identify or retrieve data from the service element 112, or vice versa. One or more of the address element 110 and the service element 112 may be stored remotely from the image capture device 102 and retrieved by one or more devices such as the image capture device 102 and the computing device 104. Other information may be represented by the service element 112.

The computing device 104 may comprise a server configured for communicating with the image capture device 102. The computing device 104 may communicate with the user device 102 for providing data and/or services. The computing device 104 may provide services such as object activity and region detection services. The computing device 104 may allow the image capture device 102 to interact with remote resources such as data, devices, and files.

The computing device 104 may comprise an image analysis module 124. The image analysis module 124 may analyze one or more images (e.g., video, frames of video, etc.) determined/captured by the image capture device 102 and determine a plurality of portions of a scene within a field of view of the image capture device 102 (e.g., the input module 111). Each portion of the plurality of portions of the scene may be classified/designated as a region of interest (ROI). A plurality of ROIs associated with a scene may be used to generate a region segmentation map of the scene. The image analysis module 124 may use a region segmentation map as baseline and/or general information for predicting/determining a plurality of portions (e.g., a street, a porch, a lawn, etc.) of a new scene in a field of view of the image capture device 102.

The image analysis module 124 may use selected and/or user provided information/data associated with one or more scenes to automatically determine a plurality of portions of any scene within a field of view of the image capture device 102. The selected and/or user provided information/data may be provided to the computing device 104 during a training/registration procedure. A user may provide general geometric and/or topological information/data (e.g., user defined regions of interest, user defined objects of interest, user defined geometric and/or topological labels associated with one or more regions or objects such as “garage door,” “front door,” “baby gate,” “refrigerator door,” etc.) to the computing device 104. The communication element 106 may display a scene in the field of view of the image capture device 102 (e.g., the input module 111). The user may use the communication element 106 (e.g., an interface, a touchscreen, a keyboard, a mouse, etc.) to generate/provide the geometric and/or topological information/data to the image analysis module 124. The user may use an interface to identify (e.g., draw, click, circle, etc.) regions of interests (ROIs) or objects of interest (OIs) within a scene. The user may tag the ROIs or OIs with labels. A region segmentation map may be generated, based on the user defined ROIs or OIs. One or more region segmentation maps may be used to train the image analysis module 114 and/or any other camera system (e.g., a camera-based neural network, etc.) to automatically identify/detect regions of interest or objects of interest within a field of view. The image analysis module 124 may use the general geometric and/or topological information/data (e.g., one or more region segmentation maps, etc.) as template and/or general information to predict/determine portions and/or regions of interest or objects of interest associated with any scene (e.g., a new scene) in a field of view of the image capture device 102.

The image analysis module 124 may determine an area within its field of view to be a region of interest or object of interest (e.g., a region or objects of interest to a user) and/or areas within its field of view that are not regions of interest or objects of interest. The image analysis module 124 may determine an area within its field of view to be a ROI or OI based on long-term analysis of events occurring within its field of view. The image analysis module 124 may determine/detect a motion event occurring within an area within its field of view and/or a determined region of interest or object of interest, such as a door opening within the field of view of the image capture device 102. The image analysis module 124 may analyze video captured by the input module 111 (e.g., video captured over a period of time, etc.) and determine whether a plurality of pixels associated with a frame of the video is different from a corresponding plurality of pixels associated with a previous frame of the video. The image analysis module 124 may tag the frame with a motion indication based on the determination whether the plurality of pixels associated with the frame is different from a corresponding plurality of pixels associated with a previous frame of the video. If a change in the plurality of pixels associated with the frame is determined, the frame may be tagged with a motion indication with a predefined value (e.g., 1) at the location in the frame where the change of pixel occurred. If it is determined that no pixels changed (e.g., the pixel and its corresponding pixel is the same, etc.), the frame may be tagged with a motion indication with a different predefined value (e.g., 0). A plurality of frames associated with the video may be determined. The image analysis module 124 may determine and/or store a plurality of motion indication.

The image analysis module 124 may determine and/or store a plurality of motion indications over a time period (e.g., a day(s), a week(s), etc.). The plurality of motion indications may be compared to a threshold. An amount of motion indications with a value of 1 may satisfy or exceed a threshold value. The threshold value may be based on any amount or value of motion indication (e.g., 99 motion indications with a value of 1 may exceed a threshold value set for 55 motion indications with a value of 1).

The image analysis module 124 may perform analysis of activity/motion events detected at different ROIs of a scene, such as a user's garage, front porch, private property, and the like, over an extended time period (e.g., hours, days, etc.). During such extended activity/motion analysis, the image analysis module 124 may determine similar activity/motion events frequently occurring within a particular ROI and record (e.g., store, accumulate, etc.) statistics associated with each activity/motion event. Regions of interest (ROIs) within the field of view of the image capture device 102 with high frequency activity/motion may be identified/determined and a user may be notified. A notification may be sent to the user (e.g., to a user device) that requests that the user confirms whether the user would like to continue to receive notifications of activity/motion occurring within a particular ROI.

The image analysis module 124 may be trained to continue or to cease providing a notification when an activity/motion event is detected in a ROI based on user provided feedback indications. The user may provide the feedback using an interface of a user device (e.g., a “Thumbs Up” button indicative of a notification being helpful; a “Thumbs Down” button indicative of a notification being unhelpful, and the like). The feedback may be sent by the user device to the analysis module 124. Based on the feedback provided from the user after viewing a notification, the camera system may continue or may cease providing notifications for the ROI associated with the notification. The camera system may continue providing notifications for the ROI associated with the notification when the feedback indicates the notification is helpful or desirable (e.g., an indication of a “Thumbs Up” in response to viewing the notification; an indication that the notification was viewed at least once; and the like). The camera system may cease providing notifications for the ROI associated with the notification when the feedback indicates the notification is not helpful or not desirable (e.g., an indication of a “Thumbs Down” in response to viewing the notification; an indication that the notification was not viewed; and the like).

The computing device 104 may manage the communication between the image capture device 102 and a database 126 for sending and receiving data therebetween. The database 126 may store a plurality of files (e.g., regions of interest, motion indications, etc.), object and/or action/motion detection algorithms, or any other information. The image capture device 102 may request and/or retrieve a file from the database 126. The database 126 may store information relating to the image capture device 102 such as the address element 110, the service element 112, one or more objects of interest, one or more regions of interest, one or more motion indications, combinations thereof, and the like. The computing device 104 may obtain the device identifier 108 from the image capture device 102 and retrieve information from the database 126 such as the address element 110 and/or the service elements 112. The computing device 104 may obtain the address element 110 from the image capture device 102 and may retrieve the service element 112 from the database 126, or vice versa. The computing device 104 may obtain the regions of interest, motion indications, object and/or action/motion detection algorithms, or the like from the image capture device 102 and retrieve/store information from the database 126, or vice versa. Any information may be stored in and retrieved from the database 126. The database 126 may be disposed remotely from the computing device 104 and accessed via direct or indirect connection. The database 126 may be integrated with the computing system 104 or some other device or system.

A network device 116 may be in communication with a network such as network 105. One or more of the network devices 116 may facilitate the connection of a device, such as image capture device 102, to the network 105. The network device 116 may be configured as a wireless access point (WAP). The network device 116 may be configured to allow one or more wireless devices to connect to a wired and/or wireless network using Wi-Fi, BLUETOOTH®, or any desired method or standard.

The network device 116 may be configured as a local area network (LAN) or wide area network (WAN). The network device 116 may be a dual band wireless access point. The network device 116 may be configured with a first service set identifier (SSID) (e.g., associated with a user network or private network) to function as a local network for a particular user or users. The network device 116 may be configured with a second service set identifier (SSID) (e.g., associated with a public/community network or a hidden network) to function as a secondary network or redundant network for connected communication devices.

The network device 116 may have an identifier 118. The identifier 118 may be or relate to an Internet Protocol (IP) Address IPV4/IPV6 or a media access control address (MAC address) or the like. The identifier 118 may be a unique identifier for facilitating communications on the physical network segment. There may be one or more network devices 116. Each of the network devices 116 may have a distinct identifier 118. An identifier (e.g., the identifier 118) may be associated with a physical location of the network device 116.

The image capture device 102 may comprise an input module 111. The input module 111 may be one or more cameras (e.g., video cameras) and/or microphones that may be used to capture one or more images (e.g., video, etc.) and/or audio of a scene within its field of view.

The image capture device 102 may comprise an image analysis module 114. The image analysis module 114 may analyze one or more images (e.g., video, frames of video, etc.) determined/captured by the image capture device 102 and determine a plurality of portions of a scene within a field of view of the image capture device 102 (e.g., the input module 111). Each portion of the plurality of portions of the scene may be classified/designated as a region of interest (ROI). A plurality of ROIs associated with a scene may be used to generate a region segmentation map of the scene. The image analysis module 114 may use a region segmentation map as baseline and/or general information for predicting/determining a plurality of portions (e.g., a street, a porch, a lawn, etc.) of a new scene in a field of view of the image capture device 102.

The image analysis module 114 may use selected and/or user provided information/data associated with one or more scenes to automatically determine a plurality of portions of any scene within a field of view of the image capture device 102. The selected and/or user provided information/data may be provided to the image capture device 102 during a training/registration procedure. A user may provide general geometric and/or topological information/data (e.g., user defined regions of interest, user defined objects of interest, user defined geometric and/or topological labels associated with one or more regions or objects such as “garage door,” “front door,” “baby gate,” “refrigerator door,” etc.) to the image capture device 102. The communication element 106 may display a scene in the field of view of the image capture device 102 (e.g., the input module 111). The user may use the communication element 106 (e.g., an interface, a touchscreen, a keyboard, a mouse, etc.) to generate/provide the geometric and/or topological information/data to the image analysis module 114. The user may use an interface to identify (e.g., draw, click, circle, etc.) regions of interests (ROIs) or objects of interest (OIs) within a scene. The user may tag the ROIs or OIs with labels. A region segmentation map may be generated, based on the user defined ROIs or OIs. One or more region segmentation maps may be used to train the image analysis module 114 and/or any other camera system (e.g., a camera-based neural network, etc.) to automatically identify/detect regions of interest or objects of interest within a field of view. The image analysis module 114 may use the general geometric and/or topological information/data (e.g., one or more region segmentation maps, etc.) as template and/or general information to predict/determine portions and/or regions of interest or objects of interest associated with any scene (e.g., a new scene) in a field of view of the image capture device 102.

The image analysis module 114 may determine an area within its field of view to be a region of interest or object of interest (e.g., a region or objects of interest to a user) and/or areas within its field of view that are not regions of interest or objects of interest. The image analysis module 114 may determine an area within its field of view to be a ROI or OI based on long-term analysis of events occurring within its field of view. The image analysis module 114 may determine/detect a motion event occurring within an area within its field of view and/or a determined region of interest or object of interest, such as a door opening within the field of view of the image capture device 102. The image analysis module 114 may analyze video captured by the input module 111 (e.g., video captured over a period of time, etc.) and determine whether a plurality of pixels associated with a frame of the video is different from a corresponding plurality of pixels associated with a previous frame of the video. The image analysis module 114 may tag the frame with a motion indication based on the determination whether the plurality of pixels associated with the frame is different from a corresponding plurality of pixels associated with a previous frame of the video. If a change in the plurality of pixels associated with the frame is determined, the frame may be tagged with a motion indication with a predefined value (e.g., 1) at the location in the frame where the change of pixel occurred. If it is determined that no pixels changed (e.g., the pixel and its corresponding pixel is the same, etc.), the frame may be tagged with a motion indication with a different predefined value (e.g., 0). A plurality of frames associated with the video may be determined. The image analysis module 114 may determine and/or store a plurality of motion indication.

The image analysis module 114 may determine and/or store a plurality of motion indications over a time period (e.g., a day(s), a week(s), etc.). The plurality of motion indications may be compared to a threshold. An amount of motion indications with a value of 1 may satisfy or exceed a threshold value. The threshold value may be based on any amount or value of motion indication (e.g., 99 motion indications with a value of 1 may exceed a threshold value set for 55 motion indications with a value of 1).

The image analysis module 114 may perform analysis of activity/motion events detected at different ROIs of a scene, such as a user's garage, front porch, private property, and the like, over an extended time period (e.g., hours, days, etc.). During such extended activity/motion analysis, the image analysis module 114 may determine similar activity/motion events frequently occurring within a particular ROI and record (e.g., store, accumulate, etc.) statistics associated with each activity/motion event. Regions of interest (ROIs) within the field of view of the image capture device 102 with high frequency activity/motion may be identified/determined and a user may be notified. A notification may be sent to the user (e.g., to a user device) that requests that the user confirms whether the user would like to continue to receive notifications of activity/motion occurring within a particular ROI.

The image analysis module 114 may be trained to continue or to cease providing a notification when an activity/motion event is detected in a ROI based on user provided feedback indications. The user may provide the feedback using an interface of a user device (e.g., a “Thumbs Up” button indicative of a notification being helpful; a “Thumbs Down” button indicative of a notification being unhelpful, and the like). The feedback may be sent by the user device to the analysis module 114. Based on the feedback provided from the user after viewing a notification, the camera system may continue or may cease providing notifications for the ROI associated with the notification. The camera system may continue providing notifications for the ROI associated with the notification when the feedback indicates the notification is helpful or desirable (e.g., an indication of a “Thumbs Up” in response to viewing the notification; an indication that the notification was viewed at least once; and the like). The camera system may cease providing notifications for the ROI associated with the notification when the feedback indicates the notification is not helpful or not desirable (e.g., an indication of a “Thumbs Down” in response to viewing the notification; an indication that the notification was not viewed; and the like).

The image capture device 102 may use the communication element 106 to notify the user of activity/motion occurring within a particular ROI. The notification may be sent to the user via a short range communication technique (e.g., BLUETOOTH®, near-field communication, infrared, etc.) or a long range communication technique (e.g., WIFI, cellular, satellite, Internet, etc.). The notification may be a text message, a notification/indication via an application, an email, a call, or any type of notification. A user may receive a message, via a user device, such as “Are you interested in the events in the region in the future?”, “do you want to be notified of events on the road?”, or any other type of message. If the user does not desire continued notification of activity/motion occurring within a particular ROI, the image capture device 102 may cease such notifications and/or filter/cease detection of activity/motion occurring within the particular ROI. By filtering/ceasing detection of activity/motion occurring within a particular ROI, the image capture device 102 may avoid/reduce notifications of action/motion events, such as trees/flags moving due to wind, rain/snow, shadows, and the like that may not be of interest to the user.

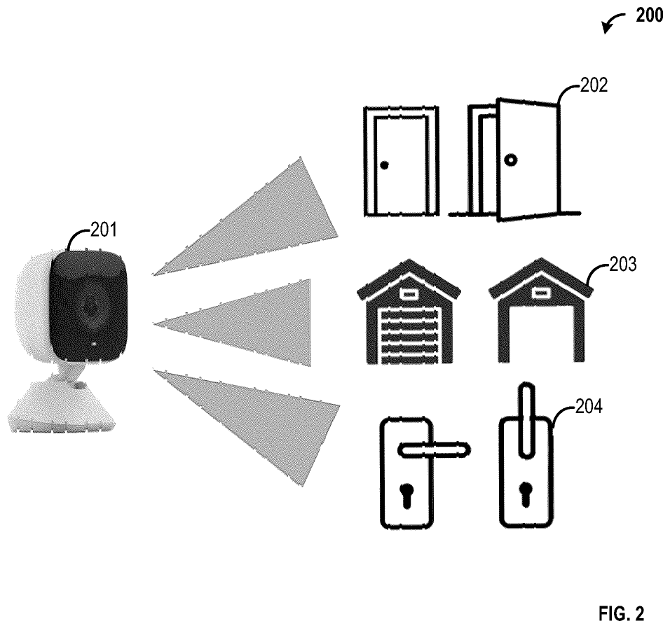

FIG. 2 shows a system 200 comprising one or more objects of interest 202, 203, and 204 in a field of view of an image capture device 201 (e.g., the image capture device 102). The one or more objects of interest are shown in one or more states. For example, a first object of interest 201 (a door) is shown in an open state and a partially open state. For example, a second object of interest 202 (a garage door) is shown in a closed state and a completely open state. For example, a third object of interest 203 is shown.

The image capture device 201 may be in communication with a computing device (e.g., the computing device 104, not shown) through a wired or wireless connection. The image capture device 201 may capture image data of the field of view. The image capture device 201 may send the image data to the computing device for analysis.

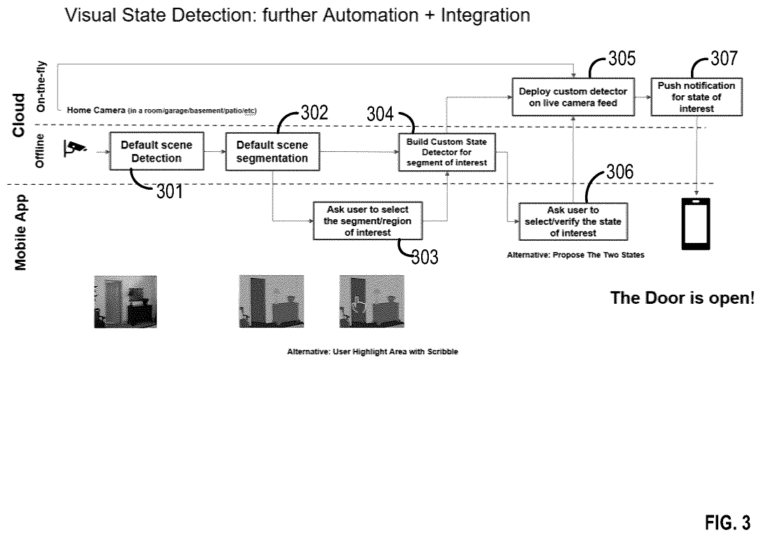

FIG. 3 shows an example method 300 for visual state detection. The method 300 may be carried out via any combination of the one or more devices described herein. The method 300 may be carried out under the assumption that in each use case, there is a dominant (e.g., a default) state. For example, the garage door is closed most of the time. Further, the state of interest may be defined as a rare (non-dominant) state for which user would like to get a notification. For example, if the object of interest is a garage door, the dominant state (the default state) may be the closed state, while the rare state (e.g., the state that will trigger a notification) is the open state. The system may incorporate a cloud architecture wherein some steps take place on a user device (e.g., a mobile phone) and wherein some steps take place in the cloud (e.g., a remote computing device). At 301, default state detection may occur. Default state detection may comprise running simple color-based frame similarity comparisons to find most dominant cluster of frames. For example, after analyzing a few hours of a camera feed, the default may be determined as the state of the object during a majority of the time. A sample image may be prepared for segmentation.

At 302, default scene segmentation may occur. Default scene segmentation may comprise leveraging an existing scene segmentation method. For example, semantic segmentation assigns each pixel in an image to a specific class or category, such as “car,” “tree,” or “person.” The goal is to identify the objects and their boundaries within the image. For example, instance segmentation may distinguish between individual instances of the same class. It assigns a unique label to each instance of an object, making it useful in scenarios with multiple objects of the same type. For example, deep learning based segmentation may be used. For example, Convolutional neural networks (CNNs) and deep learning architectures have may be used for image segmentation tasks, offering state-of-the-art performance in tasks like semantic and instance segmentation. Default scene segmentation may comprise creating a segmentation color map. The color map may be sent to a user device. Optionally, at 303, a user may select one or more segments/regions of interest. For example, the user may input one or more user inputs into a user device. At 304, a custom state detector may be built for the segment/region of interest. For example, building the custom state detector may comprise extracting an effective image embedding (e.g., YOLO-v7 or v8 or Contrastive Language-Image Pre-training (CLIP)) from segment of interest for both states and running a clustering approach to detect two states that are well-separable.

At 305, the custom detector may be deployed on a live camera feed. For example, deploying the custom detector may comprise window-based aggregation of visual state detector predictions. For example, the visual state detector generates the state prediction by applying the custom trained model on sample frames coming from the live camera feed. For example, the system may send a notification to the end user when the number of “state of interest” prediction in a given period of time (e.g., 30 s), exceeds a given threshold. For example, if out of last 20 predictions, 15 of them are “state of interest,” then the ratio (0.75) exceeds the predefined threshold (0.7) so it triggers the notification. Optionally, at 306, the user may select and/or verify the state of interest (e.g., open/closed). For example, from clustering results, a user may pick sample image (e.g., with medoid embedding) from the cluster of state of interest and share it with user for verification. At 307, one or more push notifications associated with (e.g., indicative of) the state of interest may be sent to a user device.

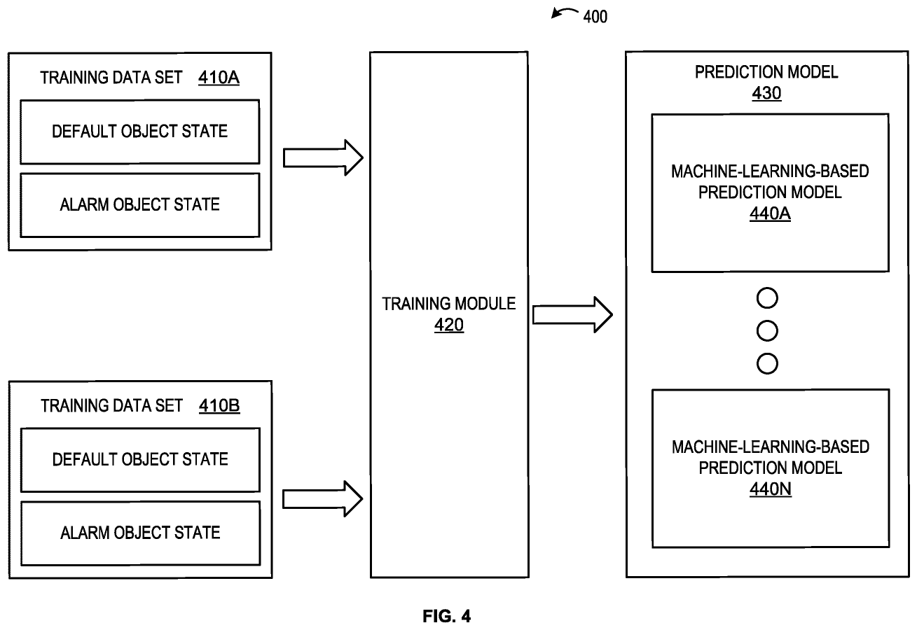

Machine-learning and other artificial intelligence techniques may be used to train a prediction model. The prediction model, once trained, may be configured to determine or identify an object state. For example, the computing device 104 of the system 100 may use the trained prediction model to determine or identify the object state. The prediction model (referred to herein as the at least one prediction model 430, or simply the prediction model 430) may be trained by a system 400 as shown in FIG. 4. The system 400 may be part of the computing device 104 or a one or more other separate computing devices configured to provide the prediction model 430 to the computing device 104, via the network 105 or another network, for analysis of object state data.

The system 400 may be configured to use machine-learning techniques to train, based on an analysis of one or more training datasets 410A-410B by a training module 420, the at least one prediction model 430. The at least one prediction model 430, once trained, may be configured to determine or identify one or more object states. A dataset may be determined or derived from one or more portions of historical data. For example, previous or historical events may be used by the training module 420 to train the at least one prediction model 430.

The training dataset 410A may comprise a first portion of the historical object state data and/or laboratory created object state data in the dataset. Each historical object state data record and/or laboratory created object state data record may have an associated object state, or likelihood of object state associated with the historical object state data record and/or laboratory created object state data record. The training dataset 410B may comprise a second portion of the historical object state data and/or laboratory created object state data in the dataset. Each historical object state data record and/or laboratory created object state data record in the second portion may have an associated object state, or likelihood of object state associated with the historical object state data record and/or laboratory created object state data record. The historical object state data and/or laboratory created object state data may be randomly assigned to the training dataset 410A, the training dataset 410B, and/or to a testing dataset. In some implementations, the assignment of historical object state data and/or laboratory created object state data to a training dataset or a testing dataset may not be completely random. In this case, one or more criteria may be used during the assignment, such as ensuring that similar numbers of historical object state data and/or laboratory created object state data items with different object states, likelihood of object states, combinations thereof, and the like, or other features are in each of the training and testing datasets. In general, any suitable method may be used to assign the historical object state data and/or laboratory created object state data to the training or testing datasets, while ensuring that the distributions of object state date and/or likelihoods object state data are somewhat similar in the training dataset and the testing dataset.

The training module 420 may use the first portion and the second portion of the plurality of historical data and/or laboratory created data to determine one or more features (which may or may not be multimodal) that are indicative of an accurate (e.g., a high confidence level for the) object state. That is, the training module 420 may determine which features associated with the plurality of historical data and/or laboratory created data are correlative with an accurate object state for a given object. The one or more features indicative of an accurate object state for a particular object may be used by the training module 420 to train the prediction model 430. For example, the training module 420 may train the prediction model 430 by extracting a feature set (e.g., one or more features) from the first portion in the training dataset 410A according to one or more feature selection techniques. The training module 420 may further define the feature set obtained from the training dataset 410A by applying one or more feature selection techniques to the second portion in the training dataset 410B that includes statistically significant features of positive examples (e.g., accurate object state for a particular object) and statistically significant features of negative examples (e.g., inaccurate object state for a particular object). The training module 420 may train the prediction model 430 by extracting a feature set from the training dataset 410B that includes statistically significant features of positive examples and statistically significant features of negative examples.

The training module 420 may extract a feature set from the training dataset 410A and/or the training dataset 410B in a variety of ways. For example, the training module 420 may extract a feature set from the training dataset 410A and/or the training dataset 410B using a detector. The training module 420 may perform feature extraction multiple times, each time using a different feature-extraction technique. In one example, the feature sets generated using the different techniques may each be used to generate different machine-learning-based prediction models 440. For example, the feature set with the highest quality metrics may be selected for use in training. The training module 420 may use the feature set(s) to build one or more machine-learning-based prediction models 440A-440N that are configured to provide an object state prediction.

The training dataset 410A and/or the training dataset 410B may be analyzed to determine any dependencies, associations, and/or correlations between features and the predetermined object states for one or more objects in the training dataset 410A and/or the training dataset 410B. The identified correlations may have the form of a list of features that are associated with different object states. The features may be considered as features (or variables) in the machine-learning context. The term “feature,” as used herein, may refer to any characteristic of an item of data that may be used to determine whether the item of data falls within one or more specific categories or within a range. By way of example, the features described herein may comprise one or more features.

A feature selection technique may comprise one or more feature selection rules. The one or more feature selection rules may comprise a feature occurrence rule. The feature occurrence rule may comprise determining which features in the training dataset 410A occur over a threshold number of times and identifying those features that satisfy the threshold as candidate features. For example, any features that appear greater than or equal to 5 times in the training dataset 410A may be considered as candidate features. Any features appearing less than 5 times may be excluded from consideration as a feature. Other threshold numbers may be used in the place of the example 5 times presented above.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training dataset 410A to generate a first list of features. A final list of candidate features may be analyzed according to additional feature selection techniques to determine one or more candidate feature groups (e.g., groups of features that may be used to predict an object state). Any suitable computational technique may be used to identify the candidate feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine-learning algorithms used by the system 400. Instead, features may be selected on the basis of scores in various statistical tests for their correlation with the outcome variable (e.g., a predicted viewing window).

As another example, one or more candidate feature groups may be selected according to a wrapper method. A wrapper method may be configured to use a subset of features and train the prediction model 430 using the subset of features. Based on the inferences that drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 420 has generated a feature set(s), the training module 420 may generate the one or more machine-learning-based prediction models 440A-440N based on the feature set(s). A machine-learning-based prediction model (e.g., any of the one or more machine-learning-based prediction models 440A-440N) may refer to a complex mathematical model for data classification that is generated using machine-learning techniques as described herein. In one example, a machine-learning-based prediction model may include a map of support vectors that represent boundary features. By way of example, boundary features may be selected from, and/or represent the highest-ranked features in, a feature set.

The training module 420 may use the feature sets extracted from the training dataset 410A and/or the training dataset 410B to build the one or more machine-learning-based prediction models 440A-440N for each classification category (e.g., object states). In some examples, the one or more machine-learning-based prediction models 440A-440N may be combined into a single machine-learning-based prediction model 440 (e.g., an ensemble model). Similarly, the prediction model 430 may represent a single classifier containing a single or a plurality of machine-learning-based prediction models 440 and/or multiple classifiers containing a single or a plurality of machine-learning-based prediction models 440 (e.g., an ensemble classifier).

The extracted features (e.g., one or more candidate features) may be combined in the one or more machine-learning-based prediction models 440A-440N that are trained using a machine-learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting prediction model 430 may comprise a decision rule or a mapping for each candidate feature in order to assign a predicted object state. As described further herein, the resulting prediction model 430 may be used to provide a predicted object state. The candidate features and the prediction model 430 may be used to predict object states of one or more objects.

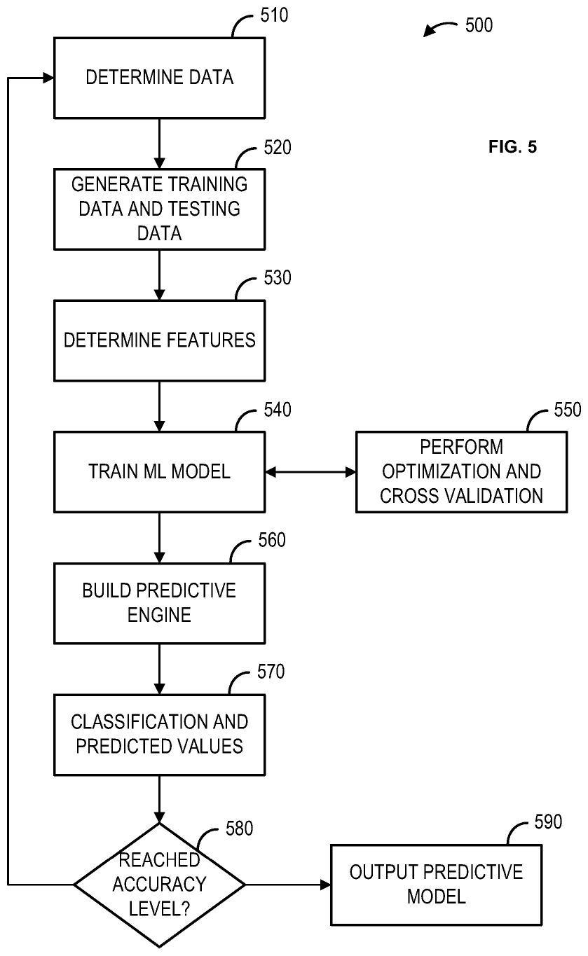

FIG. 5 is a flowchart illustrating an example training method 500 for generating the prediction model 430 using the training module 420. The training module 420 can implement supervised, unsupervised, and/or semi-supervised (e.g., reinforcement based) machine-learning-based prediction models 440A-440N. The method 500 illustrated in FIG. 5 is an example of a supervised learning method; variations of this example of training method are discussed below, however, other training methods can be analogously implemented to train unsupervised and/or semi-supervised machine-learning models. The method 500 may be implemented by the computing device 104 or by another computing device, such as a separate machine-learning computing system.

At 510, the training method 500 may determine (e.g., access, receive, retrieve, etc.) first historical object state data and/or laboratory created object state data (e.g., the first portion of the plurality of historical object state data records and/or laboratory created object state data records described above) and second historical object state data and/or laboratory created object state data (e.g., the second portion of the plurality of historical object state data records and/or laboratory created object state data records described above). The first historical object state data and/or laboratory created object state data and the second historical object state data and/or laboratory created object state data may each comprise one or more features and a predetermined object state type for one or more objects. The training method 500 may generate, at 520, a training dataset and a testing dataset. The training dataset and the testing dataset may be generated by randomly assigning historical object state data records and/or laboratory created object state data records from the first historical object state data and/or laboratory created object state data and/or the second historical object state data and/or laboratory created object state data to either the training dataset or the testing dataset. In some implementations, the assignment of historical object state data and/or laboratory created object state data as training or test samples may not be completely random. As an example, only the historical object state data and/or laboratory created object state data for a specific object state may be used to generate the training dataset and the testing dataset. As another example, a majority of the historical object state data and/or laboratory created object state data for the specific feature(s) and/or object states may be used to generate the training dataset. For example, 75% of the historical object state data and/or laboratory created object state data for the specific feature(s) and/or object states may be used to generate the training dataset and 25% may be used to generate the testing dataset.

The training method 500 may determine (e.g., extract, select, etc.), at 530, one or more features that can be used by, for example, a classifier to differentiate among different classifications (e.g., object states). The one or more features may comprise a set of features. As an example, the training method 500 may determine a set of features from the first historical object state data and/or laboratory created object state data. As another example, the training method 500 may determine a set of features from the second historical object state data and/or laboratory created object state data. In a further example, a set of features may be determined from other historical object state data and/or laboratory created object state data of the plurality of historical object state data and/or laboratory created object state data (e.g., a third portion) associated with a specific feature(s) and/or object states associated with the historical object state data and/or laboratory created object state data of the training dataset and the testing dataset. In other words, the other historical object state data and/or laboratory created object state data (e.g., the third portion) may be used for feature determination/selection, rather than for training. The training dataset may be used in conjunction with the other historical object state data and/or laboratory created object state data to determine the one or more features. The other historical object state data and/or laboratory created object state data may be used to determine an initial set of features, which may be further reduced using the training dataset.

The training method 500 may train one or more machine-learning models (e.g., one or more prediction models) using the one or more features at 540. In one example, the machine-learning models may be trained using supervised learning. In another example, other machine-learning techniques may be employed, including unsupervised learning and semi-supervised. The machine-learning models trained at 540 may be selected based on different criteria depending on the problem to be solved and/or data available in the training dataset. For example, machine-learning models can suffer from different degrees of bias. Accordingly, more than one machine-learning model can be trained at 540, and then optimized, improved, and cross-validated at 550.

The training method 500 may select one or more machine-learning models to build the prediction model 430 at 560. The prediction model 430 may be evaluated using the testing dataset. The prediction model 430 may analyze the testing dataset and generate classification values and/or predicted values (e.g., object state predictions) at 570. Classification and/or prediction values may be evaluated at 580 to determine whether such values have achieved a desired accuracy level (e.g., a confidence level for the predicted object state). Performance of the prediction model 430 may be evaluated in a number of ways based on a number of true positives, false positives, true negatives, and/or false negatives classifications of the plurality of data points indicated by the prediction model 430.

For example, the false positives of the prediction model 430 may refer to a number of times the prediction model 430 incorrectly assigned an accurate object state for one or more objects. Conversely, the false negatives of the prediction model 430 may refer to a number of times the machine-learning model assigned an inaccurate object state to a historical object state data record and/or laboratory created object state data record associated with a high confidence level. True negatives and true positives may refer to a number of times the prediction model 430 correctly assigned object states for one or more objects to a historical object state data record and/or laboratory created object state data record based on the known, predetermined objects states for one or more objects, for each historical object state data record and/or laboratory created object state data record. Related to these measurements are the concepts of recall and precision. Generally, recall refers to a ratio of true positives to a sum of true positives and false negatives, which quantifies a sensitivity of the prediction model 430. Similarly, precision refers to a ratio of true positives a sum of true and false positives. When such a desired accuracy level (e.g., confidence level) is reached, the training phase ends and the prediction model 430 may be output at 590; when the desired accuracy level is not reached, however, then a subsequent iteration of the training method 500 may be performed starting at 510 with variations such as, for example, considering a larger collection of historical object state data records and/or laboratory created object state data records.

The prediction model 430 may be output at 590. The prediction model 430 may be configured to provide predicted object states for one or more objects in a field of view of an image capture device. For example, the prediction model 430 may be trained and output by a first computing device. The first computing device may provide the prediction model 430 to a second computing device, such as the computing device. As described herein, the method 500 may be implemented by the computing device 104 or another computing device.

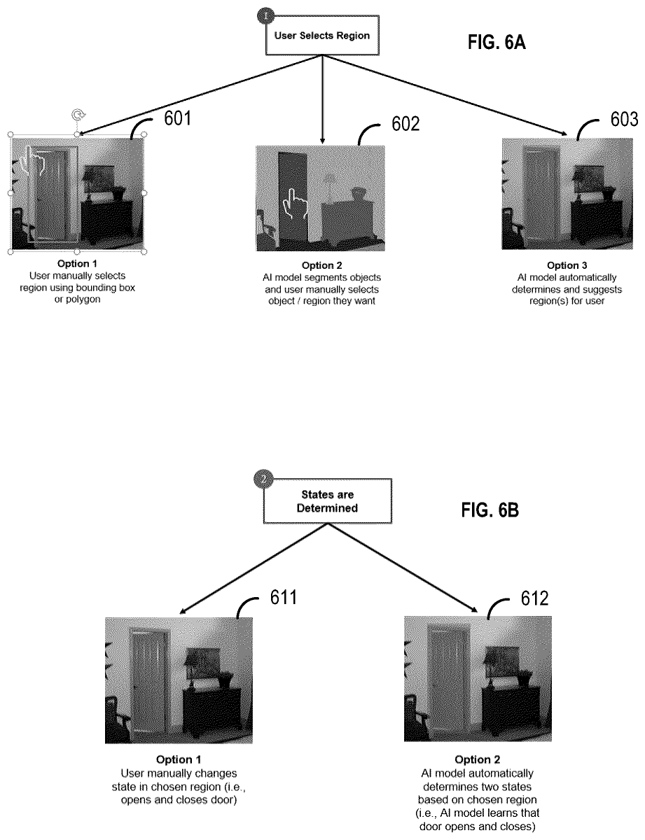

FIG. 6A shows one or more example user interfaces 601, 602, and 603. The one or more user interfaces may be configured to receive one or more user selections identifying one or more regions of interest. For example, user interface 601 may be configured to receive a user selection of the region of interest in the form of a bounding box. For example, user interface 602 may be configured to output a visual representation of an AI model segmenting one or more objects, and then the user may select the one or more objects as one or more objects of interest. For example, user interface 603 shows an AI model automatically segmenting the one or more regions or objects and suggests the one or more regions or objects to the user for selection as one or more regions of interest or one or more objects of interest.

FIG. 6B shows one or more example user interfaces 611 and 612. For example, user interface 611 may be configured to receive one or more user inputs manually changing the state of a chosen object or region. For example, user interface 612 shows an AI model automatically determining one or more states based on a chosen region. For example, the AI model may learn that the door opens and closes. The AI model may learn over time from change in a pixels or a change in the AI model's internal vector representation of the objects within the chosen region, such as those generated using object segmentation methods. The AI model may extract internal vector representations of frames from the ROI over time. Two states can be determined by splitting the AI model's internal vector representations into clusters using one of many clustering techniques, such as K-means, Gaussian Mixture Model (GMM), Spectral Clustering, or the like. The AI model may propose one or more ROIs or objects of interest for selection and/or confirmation by the user.

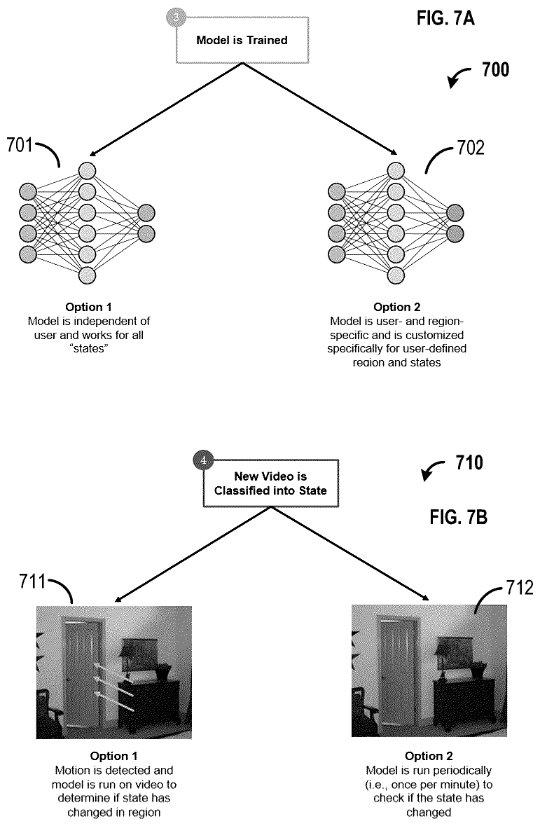

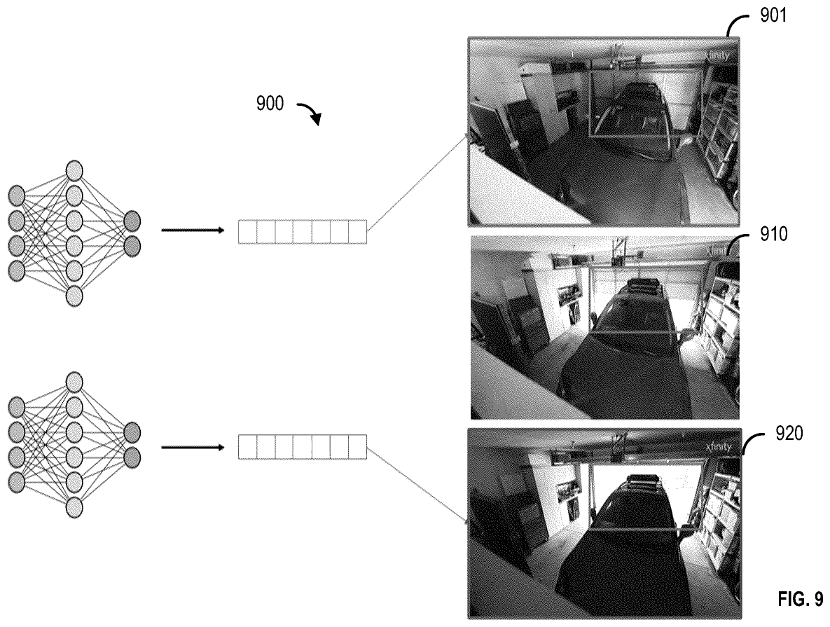

FIG. 7A shows an example method 700 for training an AI model. The method 700 may comprise any one or more of the steps of the methods described in FIGS. 4-5 and/or FIGS. 9-11. Training the model may comprise one or more options. For example a first option 701 may comprise a method where an AI model is independent of use and may be configured for all states. For example, a second option 702 may comprise a method where the model is user and region specific and is customized specifically for user-defined region and states. For example, an AI model may be trained specifically to detect the difference in the visual representation of User A's garage door open vs closed.

FIG. 7B shows an example method 710 for classifying new video. The method 710 may comprise any one or more of the steps of the methods described in FIGS. 4-5 and/or FIGS. 9-11. The method 710 may comprise one or more options. For example, a first option 711 may comprise detecting motion and running a model on video to determine if a state of an object has changed. For example, in 711, when a change in pixels is detected, or “motion” in this case, it can then be determined whether there was a change in state. This option may assume that all changes in state can also be detected by changes in pixels and that the camera can “see” that motion at the time it happens.

For example, a second option 712 may comprise running the model periodically (e.g., once per minute) to check of the state of an object of interest has changed. For example, in 712, the change in state is checked periodically. The benefit here is that if the camera is occluded or the camera is turned off, when the ROI comes back to the field of view, we can still detect the change of state without seeing the actual “motion” or change in pixels from when it happened.

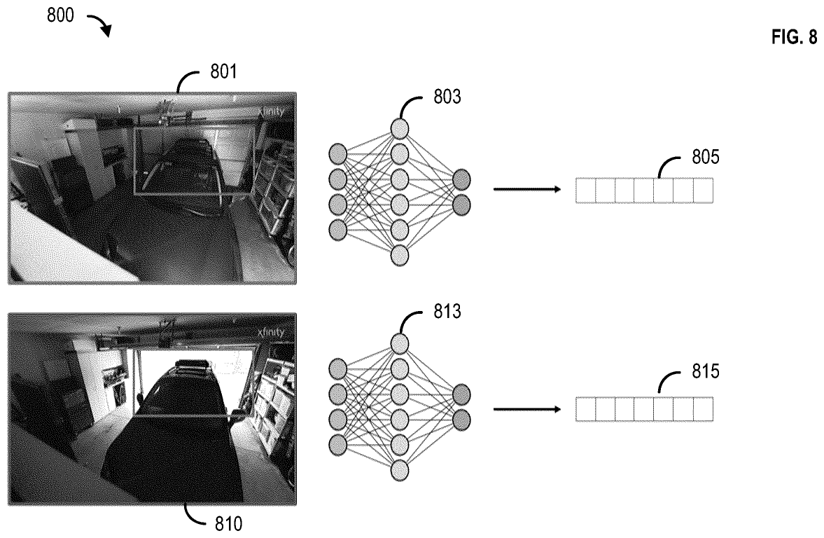

FIG. 8 shows an example method 800. The example method 800 shown in FIG. 8 is based on image data gathered from a sensor with a field of view comprising a garage door. The method 800 may comprise capturing image data 801 and image data 810. A user may indicate the image data 801 is associated with a first object state (e.g., a default state) and the image data 810 is associated with a second object station (e.g., an alarm state). For example, the image data 801 a car and a garage door. The profile of the garage door is outlined and indicates that is a region of interest or object of interest. Image data 810 includes the same field of view and also includes the car and garage door. Again, in image data 810, the area that is usually occupied by the garage door is outlined. The method may comprise converting the image data 801 and 810 to one or more vector representations (at 803 and 813, respectively). The model may convert an image of each state into a vector representation. The vector can be compared to other vectors to determine similarity. Initially, the raw image data may be acquired by the capture device. The raw image data may comprise pixel values in a grid. To make this data suitable for machine learning, the computing device may convert these images into a numerical format that can be easily processed by algorithms. This transformation involves several steps: resizing and normalization to ensure uniformity in image dimensions and pixel values, followed by feature extraction, where relevant information is distilled from the images, (e.g., through techniques like convolutional neural networks (CNNs) that identify patterns, edges, and textures). These extracted features may be organized into a numerical vector, which may serve as the input data for the machine learning model. This vectorized representation enables the model to learn and make predictions about the state of the object within the field of view, facilitating tasks such as object recognition or classification.

The region of interest may be determined by a user or may be learned over time by the system. For example, both image data 801 and 810 show the same region of interest (e.g., the space occupied by the garage door). One or more weighted sections of interest may be determined. For example, the method may employ class activation maps (CAMs), saliency maps, Gradient-weighted Class Activation Mapping (Grad-CAM), Local Interpretably Model-agnostic Explanation (LIME), Guided Grad-CAM, Shapley Additive explanations (SHAP), Feature Important from Decision Trees, combinations thereof, and the like to determine the one or more weighted sections. For example, Class Activation Maps (CAM) is a technique used in convolutional neural networks (CNNs) to visually interpret and localize the regions within an image that contribute most to the network's classification decision. CAM may generate a heatmap that highlights the critical areas influencing the model's prediction. In a CNN modified for CAM, the global average pooling layer is incorporated to aggregate feature maps from the final convolutional layer. This aggregated information is then weighted based on the learned weights of the network, producing a heatmap indicative of active or important regions.

These techniques may be employed to determine, for example, that despite the region of interest being occluded by a car, for example, the region of interest is nonetheless in a given state (e.g., open or closed, default or alarm). Thus, if an object (e.g., the car in image data 801 or 810) is occluding the region of interest, the system can nevertheless accurately predict a state of the region of interest by minimizing the weight of the occluded regions and maximizing the weights of more reliable regions. For example, the sections of the region of interest that are near the left border, upper border, and right border, are likely more accurate predictors because they are less likely to be occluded by the car.

FIG. 9 shows an example method 900 of classifying new images 901, 910, and 920 of the field of view of the image capture device comprising an object of interest (e.g., the garage door). As in FIG. 8, the image data 901, 910, and 920 in FIG. 9 can be vectorized, and the resultant vectors compared to one or more vectors associated with known object states (e.g., open/close, default/alarm). The vectors from each state are compared with new images and a similarity score is generated. This score determines whether we are in one of the two states, or neither state.

As seen in FIG. 9, image data 901 shows the garage door in a closed state. The closed state may be the default state and therefore trigger no alarm. The system may determine the image data 901 indicates the garage door is in the closed state despite the presence of the car. For example, the system may determine one or more pixels in the lower right of the region of interest are stronger predictors of object state than pixels in the center of the region of interest. The system may make this determination for a number of reasons. For example, the system may learn, over time that a given section of the region of interest is less likely to be occluded. For example, the system may learn, over time, that a section of the region of interest exhibits greater change in value (e.g., color, luminosity, etc. . . . ) when the state of the object of interest changes. For example, in the garage door scenario, the garage door opens by retracting up from the floor (e.g., perpendicular to the floor) to a state above the garage (e.g., horizontal and parallel to the floor). Thus, the first indications that the garage door is opening are along the bottom border of the region of interest. Therefore, the system may assign more weight to those sections along the bottom border of the region of interest.

For example, the system may receive image data 910, which shows a scenario where the garage door is partially open (e.g., partially raised).

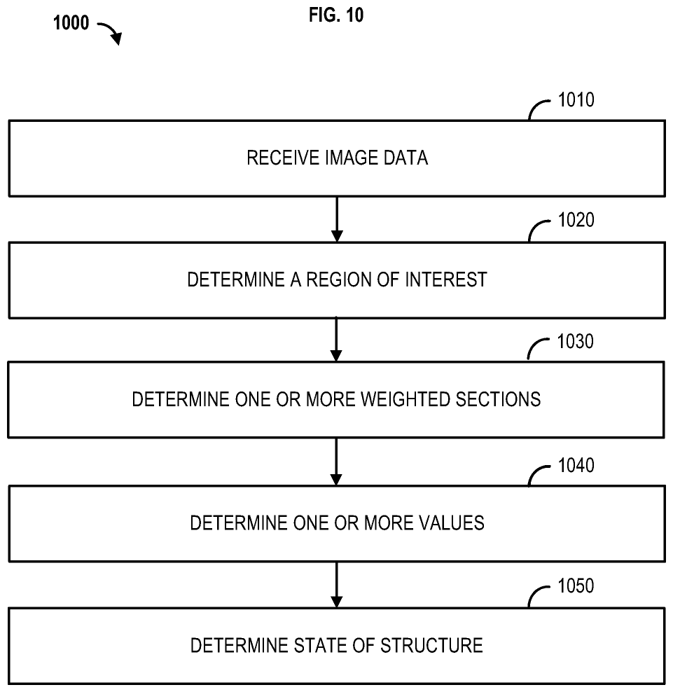

FIG. 10 is a flowchart of an example method 1000. At 1010, image data may be received. For example, the image data may be received by a computing device. For example, the image data may be received from an image capture device. The image capture device may comprise one or more photosensors/photodectors. For example, the image capture device may comprise one or more photodiodes, one or more charge-coupled devices (CCDS), combinations thereof, and the like. A photodiode is a semiconductor device that generates a current or voltage in response to the amount of light falling on it. When exposed to light, the photodiode generates an electrical current or voltage, which can be digitized using analog-to-digital converters (ADCs) to produce digital data. CCDS are composed of an array of photosensitive elements that accumulate and store electrical charge when exposed to light. The accumulated charge may then be read out (e.g., one row at a time), and converted into digital data through one or more analog-to-digital converters.

The image capture device may comprise one or more of a camera, a video camera, a motion sensor, combinations thereof, and the like. The field of view may comprise an area of a premises such as a room or a portion of a room. The field of view may comprise one or more objects of interest. The field of view may comprise one or more regions of interest. The one or more objects of interest and/or the one or more regions of interest may be determined based on a frequency of motion associated therewith. The one or more objects of interest and/or the one or more regions of interest may be determined based on a user input. The one or more objects of interest and/or the one or more regions of interest may be preconfigured.

At 1020, a region of interest may be determined. The region of interest may be determined based on, for example, one or more motion indications associated with the region of interest. For example, a motion event may be detected. The motion event may be detected from content (e.g., a plurality of images, video, etc.) captured by a camera system (e.g., the image capture device 102, etc.). The camera system may capture video of a scene within its field of view (e.g., field of view of the camera, etc.). The motion event may be detected in a portion of a plurality of portions of the scene within the field of view. The scene within the field of view may be partitioned into different regions. For example, a first field of view of a first camera may comprise a first region and a second region. For example, the first region comprise a premises door while the second region may comprise a window. For example, a second field of view associated with a second image capture device may comprise a third region and a fourth region. For example, the third region may comprise an appliance door and the fourth region may comprise a baby gate.

The regions may be automatically determined by the camera system. The regions may be determined based on a frequency of motion events within the region. For example, the first region may be determined based on the frequency of the door being opened and closed causing a plurality of motion indications to be associated with the first region. Similarly, the second region may be determined based on the window opening and closing a number of times of a period of time thereby resulting in a frequency of motion indications associated with the motion even of the window opening or closing.

They regions may be selected by a user. A region may encompass another region (e.g., a second region is part of a first region). The region may also encompass only part of another region (e.g., a first region overlaps, at least partly, with a first region). Each region within the field of view may be processed individually (e.g., a notification may be triggered and provided to a user based on motion events detected in a first region, while motion events detected in a second region may be disabled from triggering a notification) or may be processed collectively (e.g., a notification may be triggered and provided to a user based on motion events detected in either, or both, of a first region or a second region).

At 1030, one or more weighted sections of the region of interest may be determined. The region of interest may comprise one or more weighted sections. The weights of the one or more weighted sections may be determined by object segmentation methods as described herein, by determining, over time, which pixels change more frequently, and/or may be determined by a user assigning an importance level. A mask may be generated based on the region of interest. Each of the one or more weighted sections may be associated with a different weight. The one or more weights may indicate how reliably the one or more sections indicate the state of the object. The one or more weights may indicate an association between the one or more values and one or more states of the object (e.g., fully open, partially open, closed). For example, data values (e.g., grayscale data, color data, etc.) may be strongly associated with a state of the object. For example, a first weighted section of the region of interest may always be dark when the door is closed while a second weighted section of the region of interest may always be light when the door is closed. Conversely, the first weighted section may always be light when the door open (even partially open), while the second weighted section may always be light regardless of whether the door is open or closed. Thus, the image data of the first weighted section is strongly associated with the state of the object while the image data of the second weighted section is not strongly associated with the state of the object.

At 1040, one or more values associated with the one or more weighted sections may be determined. The one or more values may comprise values associated with the image data (e.g., pixel values, channel values such as red, green, blue, and alpha channels, luminosity values, grayscale values, location, depth, time information, spectral information, mask information, binary information, transparency information, opacity information). The one or more values may be determined based on the image data. The one or more values may be determined by the computing device and/or the image capture device.

At 1050, a state of the openable structure may be determined. For example, the state of the openable structure may be determined based on the one or more values (and/or changes thereof) of the one or more weighted sections satisfying the one or more thresholds. For example, a change in luminosity or grayscale data between frames of image data may indicate position of the openable structure. For example, a small change in luminosity data may indicate a change in the position of the object (e.g., a door opening) while a dramatic, large increase in luminosity data between only two frames may indicate a change in interior lighting (e.g., a person has turned on a light).

The method may comprise determining one or more identifiers associated with the image capture device, wherein the one or more identifiers comprise one or more of: one or more device identifiers, one or more data identifiers, or one or more image data fingerprints. The method may comprise determining historical image data associated with the field of view of the image capture device. The historical image data associated with the field of view of the image capture device may be determined based on receiving the image data. The method may comprise sending, based on the state of the openable structure, one or more messages. The method may comprise determining timing information associated with the image data. The method may comprise withholding, based on the timing information, a message.

The method may comprise receiving, by a computing device, from an image capture device, image data associated with a field of view of the image capture device. The method may comprise determining, based on the image data, a region of interest in the field of view, wherein the region of interest comprises an openable structure. The method may comprise determining one or more values associated with one or more weighted sections of the region of interest satisfies one or more thresholds. The method may comprise determining, based on the one or more values of the one or more weighted sections satisfying the one or more thresholds, a position of the openable structure.

The method may comprise receiving, by a computing device, from an image capture device, image data associated with a field of view of the image capture device. The method may comprise determining, based on the image data, one or more motion indications. The method may comprise determining, based on the one or more motion indications, one or more regions of interest in the field of view of the image capture device. The method may comprise applying, to the one or more regions of interest in the field of view, one or more security settings.

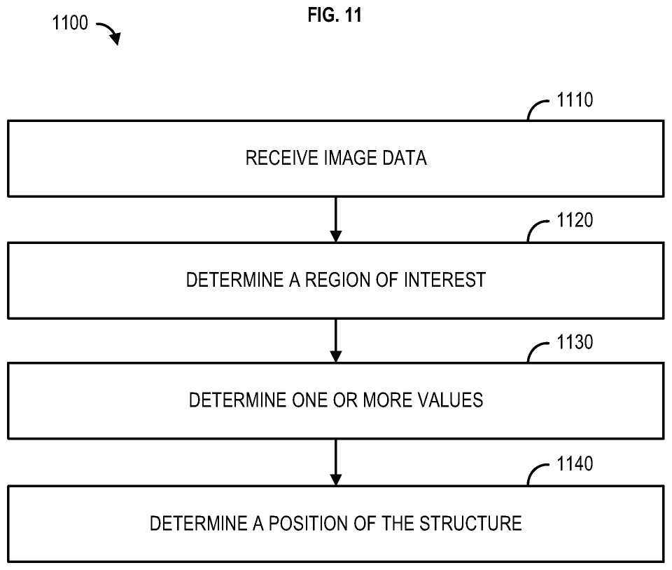

FIG. 11 is a flowchart of a method 1100. At 1110, image data may be received. For example, the image data may be received by a computing device. For example, the image data may be received from an image capture device. The image capture device may comprise one or more photosensors/photodectors. For example, the image capture device may comprise one or more photodiodes, one or more charge-coupled devices (CCDS), combinations thereof, and the like. A photodiode is a semiconductor device that generates a current or voltage in response to the amount of light falling on it. When exposed to light, the photodiode generates an electrical current or voltage, which can be digitized using analog-to-digital converters (ADCs) to produce digital data. CCDS are composed of an array of photosensitive elements that accumulate and store electrical charge when exposed to light. The accumulated charge may then be read out (e.g., one row at a time), and converted into digital data through one or more analog-to-digital converters.

The image capture device may comprise one or more of a camera, a video camera, a motion sensor, combinations thereof, and the like. The field of view may comprise an area of a premises such as a room or a portion of a room. The field of view may comprise one or more objects of interest. The field of view may comprise one or more regions of interest. The one or more objects of interest and/or the one or more regions of interest may be determined based on a frequency of motion associated therewith. The one or more objects of interest and/or the one or more regions of interest may be determined based on a user input. The one or more objects of interest and/or the one or more regions of interest may be preconfigured.

At 1120, a region of interest may be determined. For example, the region of interest may be determined based on the image data. The region of interest may comprise one or more objects of interest. For example, the one or more objects of interest may comprise one or more openable structures. For example, the one or more openable structures may comprise one or more doors (e.g., premises doors, appliance doors such as refrigerator or oven doors or the like), one or more windows, one or more gates, combinations thereof, and the like. The region of interest may comprise one or more weighted sections. A mask may be generated based on the region of interest. The region of interest may comprise one or more weighted sections. Each of the one or more weighted sections may be associated with a different weight. The one or more weights may indicate how reliably the one or more sections indicate the state of the object. The one or more weights may indicate an association between the one or more values and one or more states of the object (e.g., fully open, partially open, closed). For example, data values (e.g., grayscale data, color data, etc.) may be strongly associated with a state of the object. For example, a first weighted section of the region of interest may always be dark when the door is closed while a second weighted section of the region of interest may always be light when the door is closed. Conversely, the first weighted section may always be light when the door open (even partially open), while the second weighted section may always be light regardless of whether the door is open or closed. Thus, the image data of the first weighted section is strongly associated with the state of the object while the image data of the second weighted section is not strongly associated with the state of the object.

For example, changes in the image data associated a first section of the region of interest may be strongly associated with changes in the state of the object of interest.

At 1130, one or more values associated with the one or more weighted sections may be determined. The one or more values may comprise values associated with the image data (e.g., pixel values, channel values such as red, green, blue, and alpha channels, luminosity values, grayscale values, location, depth, time information, spectral information, mask information, binary information, transparency information, opacity information). The one or more values may be determined based on the image data. The one or more values may be determined by the computing device and/or the image capture device.

At 1140, a position of the openable structure may be determined. For example, the position of the openable structure may be determined based on the one or more values (and/or changes thereof) of the one or more weighted sections satisfying the one or more thresholds. For example, a change in luminosity or grayscale data between frames of image data may indicate position of the openable structure. For example, a small change in luminosity data may indicate a change in the position of the object (e.g., a door opening) while a dramatic, large increase in luminosity data between only two frames may indicate a change in interior lighting (e.g., a person has turned on a light).

The method may comprise determining one or more identifiers associated with the image capture device, wherein the one or more identifiers comprise one or more of: one or more device identifiers, one or more data identifiers, one or more image data fingerprints. The method may comprise determining historical image data associated with the field of view of the image capture device. For example, the historical image data associated with the field of view of the image capture device may be determined based on receiving the image data. The method may comprise sending, based on the position of the openable structure, one or more messages. The method may comprise determining timing information associated with the image data. The method may comprise withholding, based on the timing information, a message.

The method may comprise receiving, by a computing device, from an image capture device, image data associated with a field of view of the image capture device. The method may comprise determining, based on the image data, a region of interest in the field of view, wherein the region of interest comprises an openable structure. The method may comprise determining one or more weighted sections of the region of interest. The method may comprise determining one or more values associated with the one or more weighted sections of the region of interest satisfies one or more thresholds. The method may comprise determining, based on the one or more values of the one or more weighted sections satisfying the one or more thresholds, a state of the openable structure.

The method may comprise receiving, by a computing device, from an image capture device, image data associated with a field of view of the image capture device. The method may comprise determining, based on the image data, one or more motion indications. The method may comprise determining, based on the one or more motion indications, one or more regions of interest in the field of view of the image capture device. The method may comprise applying, to the one or more regions of interest in the field of view, one or more security settings.

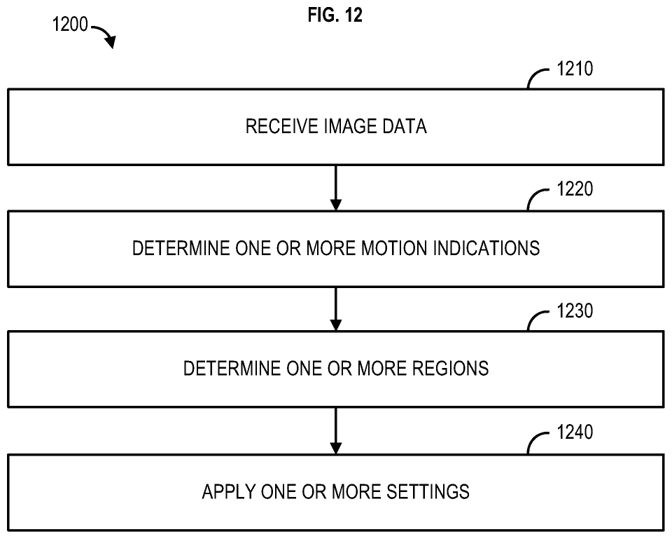

FIG. 12 is a flowchart of an example method 1200. At 1210, image data associated with a field of view may be received. The image data may be received by a computing device. The image data may be received from an image capture device. The image capture device may comprise one or more of a camera, a video camera, a motion sensor, combinations thereof, and the like. The field of view may comprise an area of a premises such as a room or a portion of a room. The field of view may comprise one or more objects of interest. The field of view may comprise one or more regions of interest. The one or more objects of interest and/or the one or more regions of interest may be determined based on a frequency of motion associated therewith. The one or more objects of interest and/or the one or more regions of interest may be determined based on a user input. The one or more objects of interest and/or the one or more regions of interest may be preconfigured.

At 1220, one or more motion indications may be determined. The one or more motion indications may comprise one or more indications configured to indicate motion occurring in the field of view of the image capture device. The one or more motion indications. For example, one or more frames of video may be compared to each other to determine the one or more motion indications. For example, each frame of the video determined to have a change in pixels from a previous frame may be tagged with a motion indication. If a change in the plurality of pixels associated with a frame is determined, the frame may be tagged with a motion indication with a predefined value (e.g., 1). The frame may be tagged with one or more motion indications. For example, depending on the number of pixels that change between frames, and which pixels change between frames (e.g., a group of pixels on the left of the frame and also a group of pixels on the right of the frame) and depending on the location in the frame where the change of pixel occurred. If it is determined that no pixels changed (e.g., the pixel(s) and its corresponding pixel(s) is the same, etc.), the frame may not be tagged with a motion indication. A plurality of frames associated with the video may be determined. The one or more motion indications may be determined and/or stored over a time period (e.g., a day(s), a week(s), etc.).

At 1230, one or more regions of interest may be determined. The one or more regions of interest may be determined based on the one or more motion indications. For example, if a region in the field of view is associated with a quantity of motion indications (e.g., over a period of time) that satisfies a motion indication frequency threshold, the region may be designated as a region of interest. For example, the quantity of motion indications may be compared to a threshold. The camera system may determine that the quantity of motion indications satisfies a threshold. Determining the one or more regions of interest may comprise determining one or more identifiers associated with the image capture device, wherein the one or more identifiers comprise one or more of: one or more device identifiers, one or more data identifiers, or one or more image data fingerprints.

At 1240, one or more security settings may be applied to the one or more regions of interest in the field of view. Security settings associated with the camera system may be based on, for example, a frequency of motion associated an object of interest and or a region of interest in the field of view. The one or more security settings may be determined to have been violated based on, for example, determining an object state. The object state may indicate, for example, that a door or window is open. The security settings may be violated, and an alarm activated, or alert or message sent, based on the door or window being open.

The method may comprise determining, based on receiving the image data, historical image data associated with the field of view of the image capture device. The method may comprise determining timing information associated with the image data. The method may comprise withholding, based on the timing information, a message.

The method may comprise receiving, by a computing device, from an image capture device, image data associated with a field of view of the image capture device. The method may comprise determining, based on the image data, a region of interest in the field of view, wherein the region of interest comprises an openable structure. The method may comprise determining one or more weighted sections of the region of interest. The method may comprise determining one or more values associated with the one or more weighted sections of the region of interest satisfies one or more thresholds. The method may comprise determining, based on the one or more values of the one or more weighted sections satisfying the one or more thresholds, a state of the openable structure.

The method may comprise receiving, by a computing device, from an image capture device, image data associated with a field of view of the image capture device. The method may comprise determining, based on the image data, a region of interest in the field of view, wherein the region of interest comprises an openable structure. The method may comprise determining one or more values associated with one or more weighted sections of the region of interest satisfies one or more thresholds. The method may comprise determining, based on the one or more values of the one or more weighted sections satisfying the one or more thresholds, a position of the openable structure.

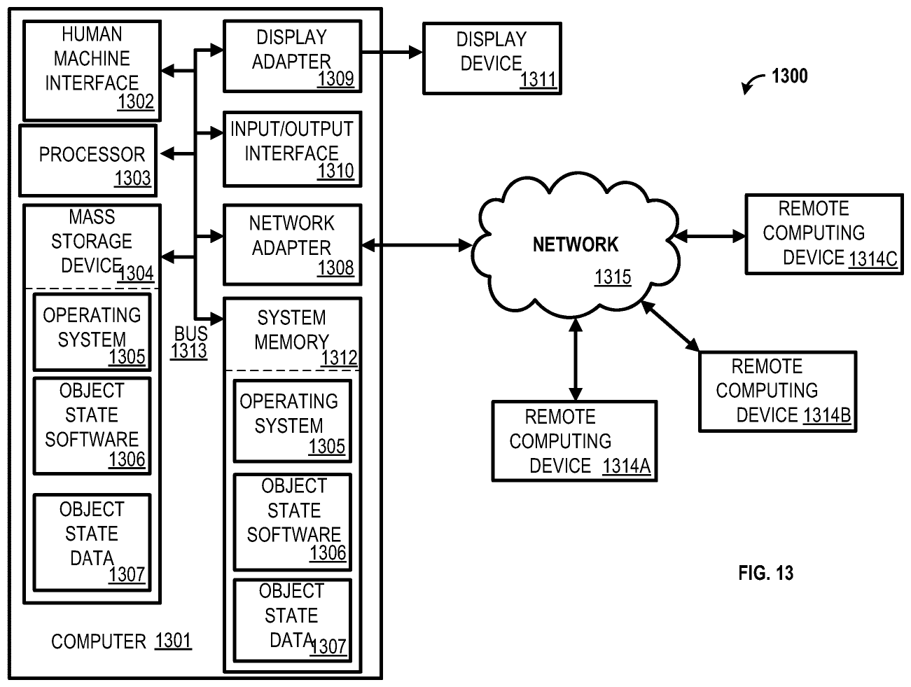

The methods and systems may be implemented on a computer 1301 as shown in FIG. 13 and described below. The image capture device 102 and the computing device 104 of FIG. 1 may be a computer 1301 as shown in FIG. 13. Similarly, the methods and systems described may utilize one or more computers to perform one or more functions in one or more locations. FIG. 13 is a block diagram of an operating environment for performing the present methods. This operating environment is a single configuration of many possible configurations of an operating environment, and it is not intended to suggest any limitation as to the scope of use or functionality of operating environment architecture. Neither should the operating environment be interpreted as having any dependency or requirement relating to any one or combination of components shown in the operating environment.

The present methods and systems may be operational with numerous other general purpose or special purpose computing system environments or configurations. Well-known computing systems, environments, and/or configurations that may be suitable for use with the systems and methods may be, but are not limited to, personal computers, server computers, laptop devices, and multiprocessor systems. Additional computing systems, environments, and/or configurations are set top boxes, programmable consumer electronics, network PCs, minicomputers, mainframe computers, distributed computing environments that are composed of any of the above systems or devices, and the like.

The processing of the present methods and systems may be performed by software components. The described systems and methods may be described in the general context of computer-executable instructions, such as program modules, being executed by one or more computers or other devices. Generally, program modules are composed of computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 1301. The components of the computer 1301 may be, but are not limited to, one or more processors 1303, a system memory 1313, and a system bus 1313 that couples various system components including the one or more processors 1303 to the system memory 1313. The system may utilize parallel computing.

The system bus 1313 represents one or more of several possible types of bus structures, including a memory bus or memory controller, a peripheral bus, an accelerated graphics port, or local bus using any of a variety of bus architectures. Such architectures may be an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1313, and all buses specified in this description may also be implemented over a wired or wireless network connection and each of the subsystems, including the one or more processors 1303, a mass storage device 1304, an operating system 1305, object identification and action determination software 1306, image data 1307, a network adapter 1308, the system memory 1313, an Input/Output Interface 1310, a display adapter 1309, a display device 1311, and a human machine interface 1302, may be contained within one or more remote computing devices 1314a,b,c at physically separate locations, connected through buses of this form, in effect implementing a fully distributed system.

The computer 1301 is typically composed of a variety of computer readable media. Readable media may be any available media that is accessible by the computer 1301 and may be both volatile and non-volatile media, removable and non-removable media. The system memory 1313 may be computer readable media in the form of volatile memory, such as random access memory (RAM), and/or non-volatile memory, such as read only memory (ROM). The system memory 1313 is typically composed of data such as the image data 1307 and/or program modules such as the operating system 1305 and the object identification and action determination software 1306 that are immediately accessible to and/or are presently operated on by the one or more processors 1303.

The computer 1301 may also be composed of other removable/non-removable, volatile/non-volatile computer storage media. FIG. 13 shows a mass storage device 1304, which may provide non-volatile storage of computer code, computer readable instructions, data structures, program modules, and other data for the computer 1301. The mass storage device 1304 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 1304, such as the operating system 1305 and the object identification and action determination software 1306. Each of the operating system 1305 and the object identification and action determination software 1306 (or some combination thereof) may be elements of the programming and the object identification and action determination software 1306. The image data 1307 may also be stored on the mass storage device 1304. The image data 1307 may be stored in any of one or more databases known in the art. Such databases are DB2®, Microsoft® Access, Microsoft® SQL Server, Oracle®, MySQL, PostgreSQL, and the like. The databases may be centralized or distributed across multiple systems.

The user may enter commands and information into the computer 1301 via an input device (not shown). Such input devices may be, but are not limited to, a keyboard, pointing device (e.g., a “mouse”), a microphone, a joystick, a scanner, tactile input devices such as gloves, and other body coverings, and the like These and other input devices may be connected to the one or more processors 1303 via the human machine interface 1302 that is coupled to the system bus 1313, but may be connected by other interface and bus structures, such as a parallel port, game port, an IEEE 1394 Port (also known as a Firewire port), a serial port, or a universal serial bus (USB).

The display device 1311 may also be connected to the system bus 1313 via an interface, such as the display adapter 1309. It is contemplated that the computer 1301 may have more than one display adapter 1309 and the computer 1301 may have more than one display device 1311. The display device 1311 may be a monitor, an LCD (Liquid Crystal Display), or a projector. In addition to the display device 1311, other output peripheral devices may be components such as speakers (not shown) and a printer (not shown) which may be connected to the computer 1301 via the Input/Output Interface 1310. Any step and/or result of the methods may be output in any form to an output device. Such output may be any form of visual representation, including, but not limited to, textual, graphical, animation, audio, tactile, and the like. The display device 1311 and computer 1301 may be part of one device, or separate devices.

The computer 1301 may operate in a networked environment using logical connections to one or more remote computing devices 1314a,b,c. A remote computing device may be a personal computer, portable computer, smartphone, a server, a router, a network computer, a peer device or other common network node, and so on. Logical connections between the computer 1301 and a remote computing device 1314a,b,c may be made via a network 1315, such as a local area network (LAN) and/or a general wide area network (WAN). Such network connections may be through the network adapter 1308. The network adapter 1308 may be implemented in both wired and wireless environments. Such networking environments are conventional and commonplace in dwellings, offices, enterprise-wide computer networks, intranets, and the Internet.

Application programs and other executable program components such as the operating system 1305 are shown herein as discrete blocks, although it is recognized that such programs and components reside at various times in different storage components of the computing device 1301, and are executed by the one or more processors 1303 of the computer. An implementation of the object identification and action determination software 1306 may be stored on or sent across some form of computer readable media. Any of the described methods may be performed by computer readable instructions embodied on computer readable media. Computer readable media may be any available media that may be accessed by a computer. Computer readable media may be “computer storage media” and “communications media.” “Computer storage media” may be composed of volatile and non-volatile, removable and non-removable media implemented in any methods or technology for storage of information such as computer readable instructions, data structures, program modules, or other data. Further, computer storage media may be, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial Intelligence techniques such as machine learning and iterative learning. Such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and methods and systems described therein be considered exemplary only, with a true scope and spirit being indicated by the following claims.

What is claimed is:

1. A method comprising:
receiving, by a computing device, from an image capture device, image data associated with a field of view of the image capture device;
determining, based on the image data, a region of interest in the field of view, wherein the region of interest comprises an openable structure;
determining one or more weighted sections of the region of interest;
determining one or more values associated with the one or more weighted sections of the region of interest satisfies one or more thresholds; and
determining, based on the one or more values of the one or more weighted sections satisfying the one or more thresholds, a state of the openable structure.

2. The method of claim 1, wherein the image capture device comprises a camera.

3. The method of claim 1, wherein the openable structure comprises one or more of: a premises door, a garage door, a gate, a fence, an appliance door, or a window.

4. The method of claim 1, wherein determining the region of interest comprises determining one or more identifiers associated with the image capture device, wherein the one or more identifiers comprise one or more of: one or more device identifiers, one or more data identifiers, or one or more image data fingerprints.

5. The method of claim 1, further comprising based on receiving the image data, determining historical image data associated with the field of view of the image capture device.

6. The method of claim 1, further comprising sending, based on the state of the openable structure, one or more messages.

7. The method of claim 1, further comprising:
determining timing information associated with the image data; and
withholding, based on the timing information, a message.

8. A method comprising:
receiving, by a computing device, from an image capture device, image data associated with a field of view of the image capture device;
determining, based on the image data, a region of interest in the field of view, wherein the region of interest comprises an openable structure;
determining one or more values associated with one or more weighted sections of the region of interest satisfies one or more thresholds; and
determining, based on the one or more values of the one or more weighted sections satisfying the one or more thresholds, a position of the openable structure.

9. The method of claim 8, wherein the image capture device comprises a camera.

10. The method of claim 8, wherein the openable structure comprises one or more of: a premises door, a garage door, a gate, a fence, an appliance door, or a window.

11. The method of claim 8, wherein determining the region of interest comprises determining one or more identifiers associated with the image capture device, wherein the one or more identifiers comprise one or more of: one or more device identifiers, one or more data identifiers, one or more image data fingerprints.

12. The method of claim 8, further comprising based on receiving the image data, determining historical image data associated with the field of view of the image capture device.

13. The method of claim 8, further comprising sending, based on the position of the openable structure, one or more messages.

14. The method of claim 8, further comprising:
determining timing information associated with the image data; and
withholding, based on the timing information, a message.

15. A method comprising:
receiving, by a computing device, from an image capture device, image data associated with a field of view of the image capture device;
determining, based on the image data, one or more motion indications;
determining, based on the one or more motion indications, one or more regions of interest in the field of view of the image capture device; and
applying, to the one or more regions of interest in the field of view, one or more security settings.

16. The method of claim 15, wherein the image capture device comprises a camera.

17. The method of claim 15, wherein determining the one or more regions of interest comprises determining one or more identifiers associated with the image capture device, wherein the one or more identifiers comprise one or more of: one or more device identifiers, one or more data identifiers, or one or more image data fingerprints.

18. The method of claim 15, further comprising based on receiving the image data, determining historical image data associated with the field of view of the image capture device.

19. The method of claim 15, wherein the field of view comprises an openable structure, the method further comprising:
determining a state of the openable structure; and
sending, based on the state of the openable structure, one or more messages.

20. The method of claim 15, further comprising:
determining timing information associated with the image data; and
withholding, based on the timing information, a message.
